(19) United States
(12) Patent Application Publication
(10) Pub. No.: US 2014/0285006 A1
(43) Pub. Date: Sep. 25, 2014

(54) Electric Energy Control Module, Apparatus and Device

(71) Applicant: Huawei Device Co., Ltd., Shenzhen (CN)

(72) Inventor: Shunhai Xu, Beijing (CN)

(21) Appl. No.: 14/296,963

(22) Filed: Jun. 5, 2014

Related U.S. Application Data
(63) Continuation of application No. PCT/CN2013/070022, filed on Jan. 4, 2013.

(30) Foreign Application Priority Data
May 22, 2012 (CN) 201210160301.1

(51) Int. Cl. H02J 1/00

(52) U.S. Cl. CPC H02J 1/00
USPC 307/23

(57) ABSTRACT

An electric energy control apparatus, module, and device are provided. The apparatus includes a first module including a first interface, a second module including a second interface, the second module includes the second interface connected to an input end of a power supply unit, an output end of power supply unit is configured to connect to an electric energy input end of external device; the first module includes the first interface connected to an input end of a charging unit, an output end of the charging unit is connected to an input end of power source unit; an output end of power source unit is connected to the first interface; an input end of detection control unit is connected to the first interface, a first output end is connected to control end of the first switch, a second output end is connected to control end of the second switch.

### CROSS-REFERENCE TO RELATED APPLICATIONS

This application is a continuation of International Application No. PCT/CN2013/070022, filed on Jan. 4, 2013, which claims priority to Chinese Patent Application No. 201210160301.1, filed on May 22, 2012, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the circuit field, and in particular, to an electric energy control module, apparatus and device.

### BACKGROUND

At present, a universal serial bus (USB) interface is widely used as one of the primary interfaces for communications between devices. Accordingly, simultaneously implementing, by using a USB interface, functions of charging a device power source and supplying power by the device power source to an external device becomes a development trend. For example, some USB wireless network cards, USB wireless modems, and the like can all use USB interfaces for charging and supplying power.

In the prior art, a charging unit for charging a device power source and a power supply unit for supplying power to an external device are generally packaged on a main board of a device.

The inventor finds that a main board of a device in the prior art generates a large amount of heat, which causes temperature increase of the device and impacts performance of the device.

### SUMMARY

In view of this, a technical problem to be solved in the present invention is to provide an electric energy control module, an apparatus and a device, so that an impact of heat generated by a main board on a temperature of a device can be reduced and performance of the device can be improved.

Embodiments of the present invention adopt the following technical solutions:

An embodiment of the present invention provides an electric energy control apparatus, including: a first module and a second module, where the first module includes a first interface, the second module includes a second interface, and the first interface and the second interface are detachably connected interfaces that cooperate with each other; the second module further includes the second interface connected to an input end of a power supply unit, where an output end of the power supply unit is configured to connect to an electric energy input end of an external device; the first module further includes the first interface connected to an input end of a charging unit by using a first switch, where an output end of the charging unit is connected to an input end of a power source unit; an output end of the power source unit is connected to the first interface by using a second switch; and an input end of a detection control unit is connected to the first interface, a first output end is connected to a control end of the first switch, and a second output end is connected to a control end of the second switch; the first interface is configured to connect to an electric energy supply end of an electric energy supply device when the power source unit is charged, and connect to the second interface when power is supplied to the external device; the charging unit is configured to, when the first switch is closed, receive electric energy supplied by the electric energy supply device, so as to charge the power source unit; the power supply unit is configured to, when the second switch is closed, receive electric energy output by the power source unit, so as to supply power to the external device; the power source unit is configured to store the electric energy when the first switch is closed, and output the electric energy when the second switch is closed; the detection control unit is configured to detect a connection status of the first interface, and control switch statuses of the first switch and the second switch according to the connection status of the first interface.

An embodiment of the present invention provides an electric energy control module, including: a first interface, where the first interface is a detachably connected interface; the first interface is connected to an input end of a charging unit by using a first switch; an output end of the charging unit is connected to an input end of a power source unit; an output end of the power source unit is connected to the first interface by using a second switch; and an input end of a detection control unit is connected to the first interface, a first output end is connected to a control end of the first switch, and a second output end is connected to a control end of the second switch; the first interface is configured to connect to an electric energy supply end of an electric energy supply device when the power source unit is charged; and when power is supplied to an external device, connect to an electric energy input end of a power supply unit that supplies power to the external device, where the power supply unit is located outside the electric energy control module; the charging unit is configured to, when the first switch is closed, receive electric energy supplied by the electric energy supply device, so as to charge the power source unit; the power source unit is configured to store the electric energy when the first switch is closed; and output the electric energy when the second switch is closed; the detection control unit is configured to detect a connection status of the first interface, and control switch statuses of the first switch and the second switch according to the connection status of the first interface.

An embodiment of the present invention provides a power supply module, including: a second interface, where the second interface is a detachably connected interface, and the second interface is configured to connect to an electric energy output interface of an electric energy output device that can output electric energy; the second interface is connected to an input end of a power supply unit; and an output end of the power supply unit is configured to connect to an electric energy input end of an external device; the power supply unit is configured to receive electric energy through the second interface, so as to supply electric energy to the external device.

Technical effects of the foregoing technical solutions are analyzed as follows:

A first module and a second module are provided, where the first module includes a first interface, the second module includes a second interface, and the first interface and the second interface are detachably connected interfaces that cooperate with each other. The second module further includes the second interface connected to an input end of a power supply unit, where an output end of the power supply unit is configured to connect to an electric energy input end of an external device. The first module further includes: the first interface connected to an input end of a charging unit by using a first switch, where an output end of the charging unit is connected to an input end of a power source unit; an output end of the power source unit is connected to the first interface by using a second switch; and an input end of a detection control unit is connected to the first interface, a first output end is connected to a control end of the first switch, and a second output end is connected to a control end of the second switch. The first interface is configured to connect to, when the power source unit is charged, an electric energy supply end of an electric energy supply device, and connect to the second interface when power is supplied to the external device. The charging unit is configured to, when the first switch is closed, receive electric energy supplied by the electric energy supply device, so as to charge the power source unit. The power supply unit is configured to receive, when the second switch is closed, electric energy output by the power source unit, so as to charge the external device. The power source unit is configured to store the electric energy when the first switch is closed, and output the electric energy when the second switch is closed. The detection control unit is configured to detect a connection status of the first interface, and control switch statuses of the first switch and the second switch according to the connection status of the first interface. The power supply unit is disposed outside a device and is connected to the first interface by using the second interface only when power needs to be supplied to the external device. The power supply unit receives the electric energy output by the power source unit and supplies power to the external device, which can reduce heat generated by a main board, thereby alleviating an impact on a temperature of the device and improving performance of the device.

### BRIEF DESCRIPTION OF THE DRAWINGS

FIG. 1 is a schematic structural diagram of an electric energy control apparatus according to an embodiment of the present invention;

FIG. 2 shows an example of an implementation structure of a first module according to an embodiment of the present invention; and

FIG. 3 shows an example of an implementation structure of a second module according to an embodiment of the present invention.

### DETAILED DESCRIPTION

The inventor finds that in the prior art, a charging unit and a power supply unit are both packaged on a main board of a device. However, switching needs to be performed between the charging unit and the power supply unit; therefore a large amount of heat is inevitably generated due to such switching, and heat is also inevitably generated during operation of the charging unit and the power supply unit, which is one of reasons for a large amount of heat generated by a main board in the prior art.

According to the foregoing, in the embodiments of the present invention, a charging unit and a power supply unit are separate, rather than being both disposed on a main board of a device, which reduces a source of generating heat on the main board, reduces heat generated by the main board, and extends a service life of the main board.

The following describes in detail the implementation of an electric energy control apparatus and device according to the embodiments of the present invention with reference to the accompanying drawings.

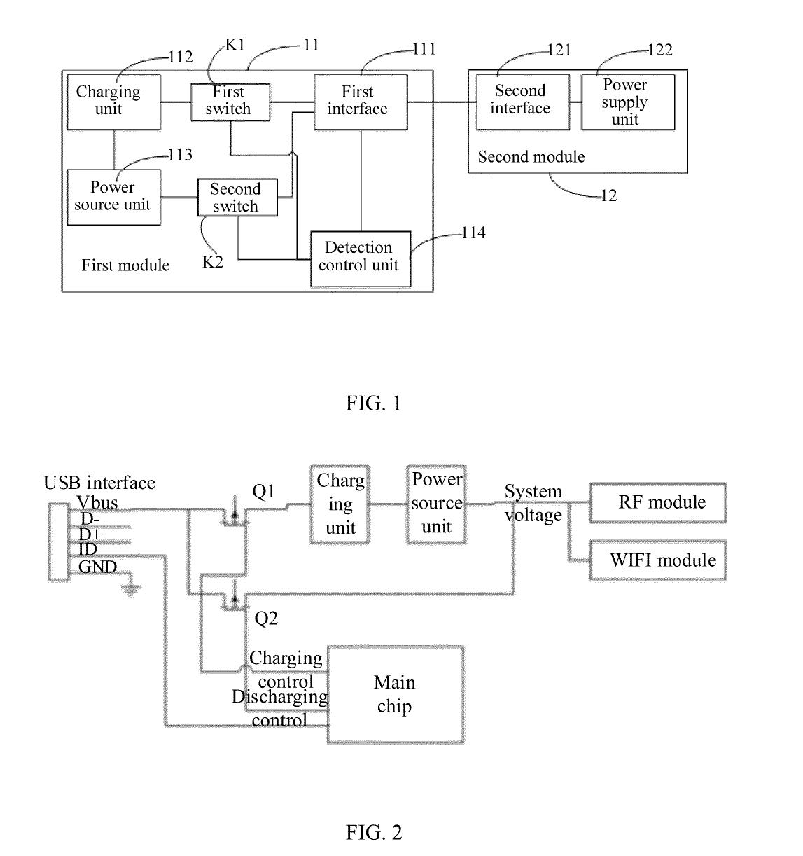

FIG. 1 is a schematic structural diagram of an electric energy control apparatus according to an embodiment of the present invention. As shown in FIG. 1, the apparatus includes a first module 11 and a second module 12, where the first module 11 includes a first interface 111, the second module 12 includes a second interface 121, and the first interface 111 and the second interface 121 are detachably connected interfaces that cooperate with each other.

The second module 12 further includes the second interface 121 connected to an input end of a power supply unit 122, where an output end of the power supply unit 122 is configured to connect to an electric energy input end of an external device.

The first module 11 further includes: the first interface 111 connected to an input end of a charging unit 112 by using a first switch K1, where an output end of the charging unit 112 is connected to an input end of a power source unit 113; an output end of the power source unit 113 is connected to the first interface 111 by using a second switch K2; and an input end of a detection control unit 114 is connected to the first interface 111, a first output end is connected to a control end of the first switch K1, and a second output end is connected to a control end of the second switch K2.

The first interface 111 is configured to connect to an electric energy supply end of an electric energy supply device when the power source unit 113 is charged, and connect to the second interface 121 when power is supplied to the external device.

The charging unit 112 is configured to, when the first switch K1 is closed, receive electric energy supplied by the electric energy supply device, so as to charge the power source unit 113.

The power supply unit 122 is configured to, when the second switch K2 is closed, receive electric energy output by the power source unit 113, so as to supply power to the external device.

The power source unit 113 is configured to store the electric energy when the first switch K1 is closed, and output the electric energy when the second switch K2 is closed.

The detection control unit 114 is configured to detect a connection status of the first interface 111, and control switch statuses of the first switch K1 and the second switch K2 according to the connection status of the first interface 111.

In the embodiment of the present invention shown in FIG. 1, the power supply unit is disposed outside a device and is connected to the first interface by using the second interface only when power needs to be supplied to an external device. The power supply unit receives electric energy output by the power source unit and supplies power to the external device, which reduces heat generated by a main board, thereby alleviating an impact on a temperature of the device and improving performance of the device.

Preferably, the detection control unit 114 may specifically be configured to control the first switch K1 to be closed and the second switch K2 to be opened when detecting that the first interface 111 is connected to the electric energy supply end of the electric energy supply device, and control the first switch K1 to be opened and the second K2 to be closed when detecting that the first interface 111 is connected to the second interface 121.

The first switch K1 and the second switch K2 may be implemented separately by using single-pole single-throw switches, or may be implemented by using a single-pole double-throw switch, or may be implemented separately by using field-effect transistors. Control ends of the first switch K1 and the second switch K2 are grid electrodes of the field-effect transistors. In such a case, the detection control unit 114 may have control over opening or closing of the field-effect transistor by outputting a corresponding driving signal to the grid electrode of the field-effect transistor.

In addition, the first interface and the second interface may be implemented by using USB interfaces. For example, one interface serves as a USB slot, and the other interface serves as a USB plug, so as to implement a detachable connection.

In such a case, the detection control unit 114 may implement detection on the connection status of the first interface 111 by detecting a level of an identifier (ID) pin of the first interface 111. For example, it may be preset that when the level of the ID pin is a high level, it indicates that the power source unit is charged, and when the level of the ID pin is a low level, it indicates that the power source unit supplies power to the external device. Accordingly, in a practical application, corresponding levels of an ID pin may be output in two different application environments, so that the detection control unit 114 can detect a corresponding level, control a corresponding switch to be closed, and implement a charging or discharging function. Accordingly, the detection control unit 114 may specifically be configured to detect the level of the ID pin of the first interface 111, control the first switch K1 to be closed and the switch K2 to be opened when the level of the ID pin is a high level, and control the first switch K1 to be opened and the second switch K2 to be closed when the level of the ID pin is a low level.

In a practical application, the first module 11 may be disposed on a printed circuit board (PCB) board of a device, and the second module may be disposed in a cable or a board outside the device.

The charging unit and the power supply unit are no longer disposed on a main board of a same device. Therefore, difficulty in laying out the main board is reduced. In addition, an area of the main board of the device may also be decreased, thereby decreasing a size of the device.

In addition, the power supply unit is disposed outside the device, and therefore, a heat source that generates heat on the main board of the device is reduced and heat generated by the main board is reduced, a service life of the main board is extended, and amplitude of temperature increase of the device is reduced.

Moreover, the power supply unit is not disposed on the main board, which may alleviate an impact of the power supply unit on layout and performance of a radio frequency part on the main board.

In the electric energy control apparatus according to the embodiment of the present invention, the first module 11 and the second module 12 may separately exist.

An embodiment of the present invention further provides an electric energy control module. Implementation of the electric energy control module is the same as a structure of the first module shown in FIG. 1. However, for the electric energy control module, a first interface is configured to connect to an electric energy supply end of an electric energy supply device when a power source unit is charged, and when power is supplied to an external device, connect to an electric energy input end of a power supply unit that supplies power to the external device, where the power supply unit is located outside the electric energy control module and the electric energy input end herein may be implemented by using the second interface. For implementation of the electric energy control module in this embodiment of the present invention, reference may be made to the foregoing description of the first module, which is not described herein again.

The electric energy control module may be disposed on a certain device that needs to be charged and supply power to an external device, such as a portable terminal.

An embodiment of the present invention further provides a power supply module. Implementation of the power supply module is the same as a structure of the second module shown in FIG. 1, which includes: a second interface 121, where the second interface 121 is a detachably connected interface; and the second interface 121 is configured to connect to an electric energy output interface of an electric energy output device that can output electric energy, where the electric energy output device herein may be a device in which the foregoing electric energy control module is located, and is used together with the electric energy control module; or the electric energy output device may be another device that can output electric energy, and in such a case, it is required that the electric energy output interface of the electric energy output device can be used together with the second interface to implement transmission of electric energy from the electric energy output device to the power supply module.

The second interface 121 is connected to an input end of a power supply unit 122, and an output end of the power supply unit 122 is configured to connect to an electric energy input end of an external device.

The power supply unit 122 is configured to receive electric energy through the second interface 121, so as to supply power to the external device.

The power supply module is disposed in a cable or a board outside the electric energy output device.

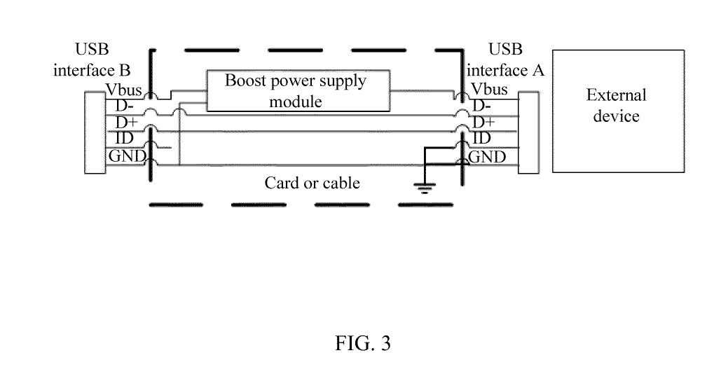

In addition, specific implementation structures of the charging unit and the power supply unit in the embodiment of the present invention are not limited, as long as functions of charging the power source unit and supplying power to the external device can be implemented. For a purpose of clarity, the following FIG. 2 and FIG. 3 illustrate specific implementation structures of a charging unit and a power supply unit, respectively.

FIG. 2 is a schematic diagram of an implementation structure of a first module according to an embodiment of the present invention.

The first module may be implemented by using a board, where a USB port shown in FIG. 2 is a standard 5-wire USB interface, may externally connect to a standard USB cable, and may be used for data communications by connecting to a standard personal computer (PC) or the like. Two field-effect transistors, namely a first field-effect transistor Q1 and a second field-effect transistor Q2, are used on the board to perform separation and switching on a circuit of a power source of the USB port, where the first field-effect transistor Q1 and the second field-effect transistor Q2 correspond to the first switch and the second switch. The control permission of switching is determined by a main chip of the board and the main chip corresponds to the detection control unit. After startup, the main chip tacitly approves that the first field-effect transistor Q1 is connected and the second field-effect transistor Q2 is disconnected, and tacitly approves that a charging unit is connected. The charging unit charges a power source unit, so that the charging unit supplies a system voltage to the first switch, the second switch, and other modules such as a radio frequency (RF) module and a wireless fidelity (WIFI) module on the board, to ensure system security. When an external cable is inserted, the main chip detects a level of an ID pin of an inserted signal, and according to a USB protocol, if the level of the ID pin is a low level, enters an on-the-go (OTG) mode, in which the first field-effect transistor Q1 is disconnected, the second field-effect transistor Q2 is connected, and the system voltage is connected to an external board through a USB port on the board; and if the level of the ID pin is high, an original mode is maintained, in which power is externally obtained and the charging unit charges the power source unit.

FIG. 3 is a schematic diagram of an implementation structure of a second module according to an embodiment of the present invention. As shown in FIG. 3, the second module is implemented through a principle of an external connection cable card.

A pin D−/D+is directly connected without any processing; a pin Vbus is connected to a circuit of a boost power supply module, where the boost power supply module corresponds to the power supply unit and the system voltage of the first module is boosted to a standard 5 volts (V) voltage; and a USB port B corresponds to the second interface and connects to another corresponding interface of a device that can communicate with and supply power to an external device, for example, connects to a first interface of a device that includes a first module, whereas an ID signal of a USB port A that is close to the external device is directly grounded and the power supply unit supplies power to the external device through the USB port A. After the power source is transformed by the second module, data communications can be normally performed and a standard 5 V power source can be supplied to another device. The external device can be implemented by using a certain board.

The foregoing descriptions are merely exemplary embodiments of the present invention. It should be noted that several improvements and polishing may also be made by a person of ordinary skill in the art without departing from the principle of the present invention, and such improvements and polishing shall also fall within the protection scope of the present invention.

What is claimed is:

1. An electric energy control apparatus, comprising:
a first module; and
a second module,
wherein the first module comprises a first interface, the second module comprises a second interface, and the first interface and the second interface are detachably connected interfaces that cooperate with each other,
wherein the second interface is connected to an input end of a power supply unit, and an output end of the power supply unit is configured to connect to an electric energy input end of an external device,
wherein the first interface is connected to an input end of a charging unit by using a first switch, and an output end of the charging unit is connected to an input end of a power source unit,
wherein an output end of the power source unit is connected to the first interface by using a second switch,
wherein an input end of a detection control unit is connected to the first interface, a first output end is connected to a control end of the first switch, and a second output end is connected to a control end of the second switch,
wherein the first interface is configured to connect to an electric energy supply end of an electric energy supply device when the power source unit is charged, and connect to the second interface when power is supplied to the external device,
wherein the charging unit is configured to receive electric energy supplied by the electric energy supply device to charge the power source unit when the first switch is closed,
wherein the power supply unit is configured to receive electric energy output by the power source unit to supply power to the external device when the second switch is closed,
wherein the power source unit is configured to store the electric energy when the first switch is closed, and output the electric energy when the second switch is closed, and
wherein the detection control unit is configured to detect a connection status of the first interface, and control switch statuses of the first switch and the second switch according to the connection status of the first interface.

2. The apparatus according to claim 1, wherein the first module is disposed on a printed circuit board (PCB) of a device, and wherein the second module is disposed in a cable or a board outside the device.

3. The apparatus according to claim 1, wherein the detection control unit is specifically configured to:
control the first switch to be closed and the second switch to be opened when detecting that the first interface is connected to the electric energy supply end of the electric energy supply device; and
control the first switch to be opened and the second switch to be closed when detecting that the first interface is connected to the second interface.

4. The apparatus according to claim 1, wherein the first interface and the second interface are USB interfaces, and wherein the detection control unit is specifically configured to:
detect a level of an identifier (ID) pin of the first interface;
control the first switch to be closed and the second switch to be opened when the level of the ID pin is a high level; and
control the first switch to be opened and the second switch to be closed when the level of the ID pin is a low level.

5. The apparatus according to claim 1, wherein the first switch and the second switch are implemented separately by using single-pole single-throw switches.

6. The apparatus according to claim 1, wherein the first switch and the second switch are implemented by using a single-pole double-throw switch.

7. The apparatus according to claim 1, wherein the first switch and the second switch are implemented separately by using field-effect transistors.

8. An electric energy control module, comprising:
a first interface that is a detachably connected interface,
wherein the first interface is connected to an input end of a charging unit by using a first switch,
wherein an output end of the charging unit is connected to an input end of a power source unit,
wherein an output end of the power source unit is connected to the first interface by using a second switch,
wherein an input end of a detection control unit is connected to the first interface, a first output end is connected to a control end of the first interface, and a second output end is connected to a control end of the second switch,
wherein the first interface is configured to connect to an electric energy supply end of an electric energy supply device when the power source unit is charged and connect to an electric energy input end of a power supply unit that supplies power to an external device when power is supplied to the external device,
wherein the power supply unit is located outside the electric energy control module,
wherein the charging unit is configured to receive electric energy supplied by the electric energy supply device to charge the power source unit when the first switch is closed,
wherein the power source unit is configured to store the electric energy when the first switch is closed and output the electric energy when the second switch is closed, and
wherein the detection control unit is configured to detect a connection status of the first interface, and control switch statuses of the first switch and the second switch according to the connection status of the first interface.

9. The module according to claim 8, wherein the electric energy control module is disposed on a printed circuit board (PCB) of a device.

10. The module according to claim 8, wherein the detection control unit is specifically configured to:
control the first switch to be closed and the second switch to be opened when detecting that the first interface is connected to the electric energy supply end of the electric energy supply device; and
control the first switch to be opened and the second switch to be closed when detecting that the first interface is connected to the electric energy input end of the power supply unit.

11. The module according to claim 8, wherein the first interface is a universal serial bus (USB) interface, and wherein the detection control unit implements the detection on the connection status of the first interface by detecting a level of an identifier (ID) pin of the first interface.

12. The module according to claim 8, wherein the first switch and the second switch are implemented separately by using single-pole single-throw switches.

13. The module according to claim 8, wherein the first switch and the second switch are implemented by using a single-pole double-throw switch.

14. The module according to claim 8, wherein the first switch and the second switch are implemented separately by using field-effect transistors.

15. A power supply module, comprising:
a second interface that is a detachably connected interface,
wherein the second interface is configured to connect to an electric energy output interface of an electric energy output device that can output electric energy,
wherein the second interface is connected to an input end of a power supply unit,
wherein an output end of the power supply unit is configured to connect to an electric energy input end of an external device, and
wherein the power supply unit is configured to receive electric energy through the second interface to supply electric energy to the external device.

16. The module according to claim 15, wherein the power supply module is disposed in a cable or a board outside an electric energy output device.
